(19) United States
(12) Patent Application Publication
(10) Pub. No.: US 2005/0107088 A1
(43) Pub. Date: May 19, 2005

(54) Wireless lan backgroud scan method

(75) Inventor: Satoshi Oura, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/985,820

(22) Filed: Nov. 10, 2004

(30) Foreign Application Priority Data
Nov. 19, 2003 (JP) 2003-389428

(51) Int. Cl. H04B 1/16

(52) U.S. Cl. 455/450

(57) ABSTRACT

A station divides all CHs available for assignment to an AP into a plurality of groups. CHs being included in one group are checked to determine whether or not there exists an AP that uses each of the CHs included in one group, based on an instruction of background scan from an OS and the like. Further, for CHs being included in the next group, the station checks whether or not there exists an AP that uses each of the CHs included in the next group based on the next instruction of background scan from an OS. As a result, the time required for one background scan can be reduced so as to have less impact on the communication the station is performing.

This application claims priority to Japanese Patent Application NO.: 2003-389428, filed on Nov. 19, 2003, which is incorporated herein by reference.

### TECHNICAL FIELD

The present application relates to a background scan method, and more specifically, to a background scan method for use in searching an access point of a wireless LAN other than the one being used in communication.

### BACKGROUND

Wireless LAN access points (AP) are being set up in public spaces and stores to allow general customers to receive various services.

An apparatus to access an AP in a wireless LAN is often a portable information processing device (hereinafter, referred to as station) such as a PC and a PDA, having functionality to search for a connectable AP other than the one with which the device is currently communicating. The search function is provided as a means for checking other channels, without disconnecting the link in communication and for performing smooth reconnection and roaming during link fragmentation.

FIG. 4 is a block diagram showing a configuration of a general wireless LAN comprising a plurality of APs and a station, FIG. 5 is a timing chart illustrating a background scan method according to the prior art, and FIG. 6 is a flow chart illustrating processing operations in the station in which the background scan according to the prior art is performed As shown in FIG. 4, a wireless LAN comprises a portable station 11 such as a PC and a PDA, and a plurality of APs 12 provided in the public spaces. Further, the station 11 has an upper level function such as an OS 14. Moreover, while only one station is shown in FIG. 4, there can be a plurality of stations. In such a wireless LAN configuration, the station 11 performs a processing to check an existence of another AP in the vicinity of the station 11 itself, such that, while a link is established with one channel (hereinafter, referred to as CH) to communicate with an AP 12, the station can promptly make a connection with another AP when the connection with the AP 12 becomes unstable.

This processing is referred to as a background scan, and can be done in a way that the station 11 performs the processing under its own control or in a way that the station 11 performs the processing based on an instruction from the upper level device such as an OS 14. In the background scan in which the station 11 performs under its own control, the station checks a status of communication traffic of its own without influencing its own communication. Further, in the background scan in which the station 11 performs based on an instruction from the upper level device such as the OS 14, the station 11 performs the background scan based on the background scan instruction issued from the OS 14 for a predetermined interval, e.g., every 1 minute. This background scan should be performed even when communication traffic of the station 11 is heavy.

Next, operations in the background scan processing that the station performs based on the prior art will be described with reference to the timing chart shown in FIG. 5.

In FIG. 5, it is assumed, for example, that the station 11 performs its own communication using 38 channels (CHs). Here, when there is a background scan instruction from the OS 14, the station 11 keeps performing its own communication for 800 ms designated as T1, issues a probe request (search signal) using one CH for the following 100 ms designated as T2, and performs a processing to check whether or not there exists another AP that uses that CH in its own vicinity, based on whether or not the corresponding response can be obtained.

For the following 800 ms designated as T3, the station 11 performs its own communication, and for the following 100 ms designated as T4, performs a processing to check whether or not there exists another AP that uses a CH, which is different from the one used in time T2, in the same manner described above.

The station 11 performs the foregoing processing repetitively to check, for each CH in which an AP is available, an existence of the AP that uses the CH. This processing is typically performed for all CHs in the 2.4 GHz range and all CHs in the 5.0 GHz range.

Next, operations in the background scan processing that the station performs based on the prior art will be described with reference to the flowchart shown in FIG. 6.

(1) Before starting the background scan, the station first stores CH information on a link, with which the station itself is currently communicating, into an internal buffer, and sets the CH number n, in which the search is performed, to an initial value (steps 601 and 602).

(2) Next, for the CHn set in the step 602, the station checks whether or not there exists another AP and stores information of the checked result into the internal buffer, as described above (steps 603 and 604).

(3) Next, the station updates the checking CH number n to n+1, and resumes its own communication using the CH of the link which was using in the station itself and was stored in the step 601 (steps 605 and 606).

(4) The station determines whether or not the check is completed for all CHs while keeps performing its communication in the step 606. If the check is not completed, the station returns to the step 603 and repeats the processing until the check for all CHs is completed. If the check for all CHs is completed, the station reports information of the checked result stored in the internal buffer to the OS and finishes the processing (steps 607 and 608).

In general, the background scan for all CHs takes a long time, e.g., 18 seconds. For this reason, in the conventional background scan method, when the traffic for its own communication is heavy, if there is a background scan instruction, there is a problem in that information being communicated with can be confused over images, in particular, animations, while the background scan is performed.

Further, one of the prior art relating to the background scan is disclosed in Japanese Unexamined Patent Application Publication No. 2001-94572.

### SUMMARY

A background scan method is described in which the time needed for one background scan is reduced with less impact on the communication the station performs.

According to an aspect of the method, there is provided a background scanning method in which a station, during communication with an AP of a wireless LAN, searches another for other APs, the method comprising: a step of dividing CHs available to the AP into a plurality of groups; for CHs being included in one group, a step of checking whether or not there exists an AP that uses each of the CHs included in one group, based on an instruction of a background scan from an OS, supervisory program, or the like, which may be embodied as instructions stored in volatile or non-volatile computer memory and executed by a processor; and for CHs being included in the next group, a step of checking whether or not there exists an AP that uses each of the CHs included in the next group, based on the next instruction of a background scan, in which the steps are performed repetitively.

Further, according to another aspect of the method, the step of dividing CHs into the plurality of groups may be performed including CHs in the 2.4 GHz range and CHs in the 5.0 GHz range or the step of dividing CHs into the plurality of groups may be performed such that CHs having a high probability, which can be allocated to closely located APs, are gathered into one group.

Moreover, according to still another aspect of the method, an initial background scan is performed for CHs in a group comprising the CH with which the station itself is communicating.

### BRIEF DESCRIPTION OF THE DRAWINGS

FIG. 1 is a timing chart illustrating a background scan method according to an embodiment;

FIG. 2 is a flowchart illustrating processing operations in a station in which the background scan method is preformed according to the embodiment;

FIG. 3 is a diagram showing an example of a construction of group tables in which CH numbers are stored;

FIG. 4 is a block diagram showing a configuration of a general wireless LAN comprising a plurality of APs and a station;

FIG. 5 is a timing chart illustrating a background scan method according to the prior art; and

FIG. 6 is a flowchart illustrating processing operations in the station in which the background scan according to the prior art is performed.

### DETAILED DESCRIPTION

Exemplary embodiments may be better understood with reference to the drawings, but these embodiments are not intended to be of a limiting nature. Like numbered elements in the same or different drawings perform equivalent functions.

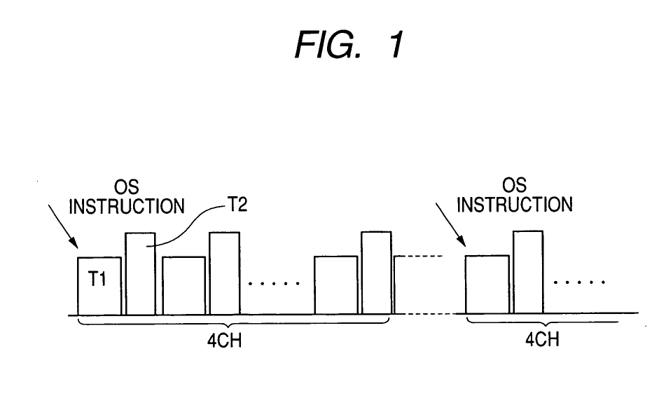

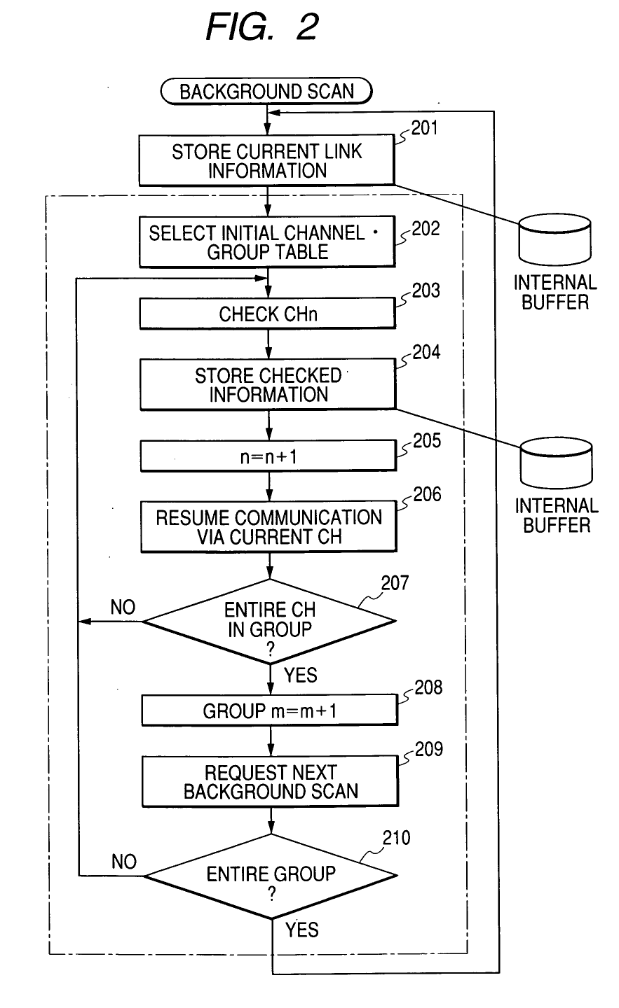

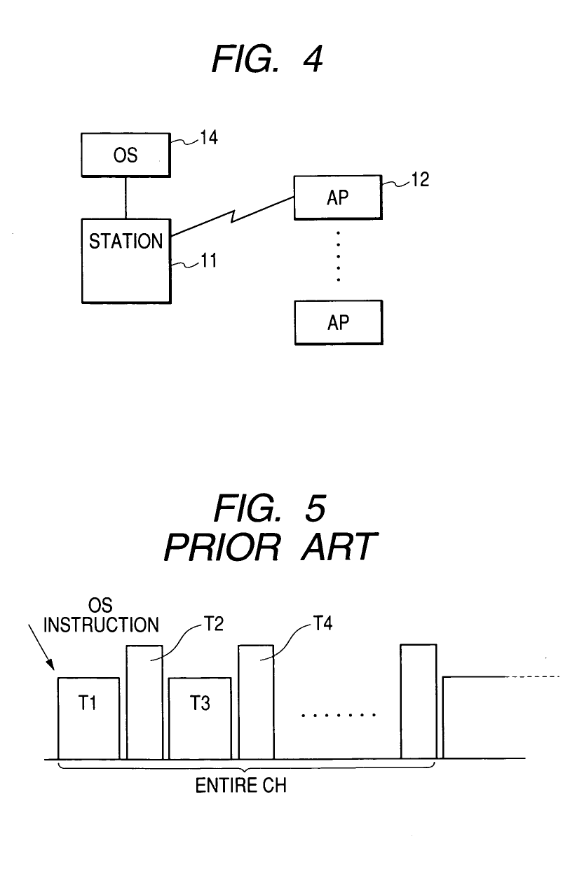

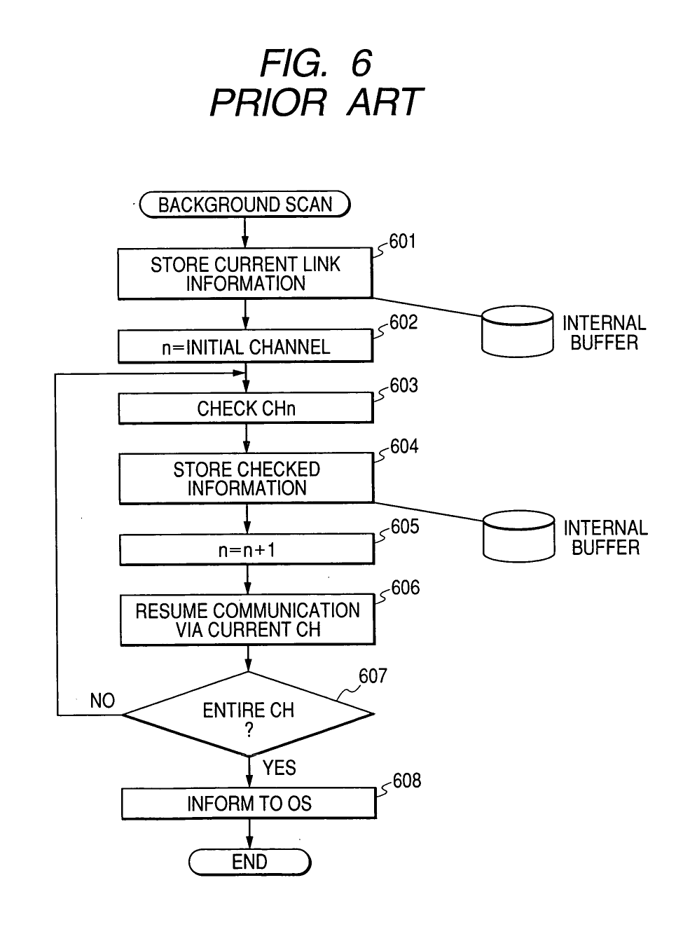

FIG. 1 is a timing chart illustrating a background scan method according to an embodiment of the method, and FIG. 2 is a flowchart illustrating processing operations in a station in which the background scan method is performed. The wireless LAN to which the method is applied may have the same configuration as shown in FIG. 4. Thus, the method will be described assuming that the wireless LAN has a configuration shown in FIG. 4.

According to an embodiment of the method, instead of checking for all CHs whether or not there exists another AP for each CH based on one background scan instruction from an OS or the like, a station divides CHs, in which APs may be available, into a plurality of groups and checks for CHs included in one group to determine whether or not there exists another AP for each CH, based on one background scan instruction from the OS or the like. (The term OS is meant to convey that a stored set of computer instructions or program intended to be executed by a microprocessor, or the like, provides at least the basis for the background scan instruction, dependent on other state information of the device, and any external stimuli that may be provided thereto, and that a result of the background scan may be received by the OS and processed further to determine a subsequent course of action. Other programs may be required for the overall function of the method. Other terms that may be used to describe such a set of instructions are supervisory program, application program, user program, and the like. The program may also perform or control other functions. The term OS will be used to describe all of these in a generic fashion.) Further description of dividing CHs into the plurality of groups will be found below. A case in which the number of CHs included in one group is 4 is described. However, the determination how many CHs are included in one group, and the composition of each group may be arbitrarily set.

In FIG. 1, it is assumed that a station 11 performs its own communication using 38 CHs, for example. When there is a background scan instruction from the OS 14, the station 11 keeps performing its own communication for 800 ms designated as T1, selects one group composed as described above, issues a probe request (search signal) using one CH included in the group for the following 100 ms designated as T2, and performs processing to check whether or not there exists another AP that uses that CH in the vicinity of the station itself, based on whether or not an appropriate response can be obtained. These operations are repetitively performed. Further, according to the method, when the processing to check for the set of 4 CHs is completed, the processing of the background scan is completed until a further instruction is received. And then, when the next background scan instruction is issued from the OS 14, the processing to check for CHs included in the next group is performed. According to this example, the time required for one background scan may be reduced. Further, the time required for the station 11 to perform its own communication can be set longer.

The method can reduce the time required for one background scan through the processing described above, so that the background scan can be performed without producing a negative impact on the communication of the station.

The operations in the background scan processing performed in the station will be described with reference to the flowchart shown in FIG. 2.

(1) Before starting the background scan, the station first stores CH information relating to a link with which the station itself is currently communicating into an internal buffer, and selects a CH number n, for which the search is to be performed, and a group table numbered m that includes the CH number. Here, the CH number n is a CH number of a record stored in the beginning of the selected group table (steps 201 and 202).

(2) For the CHn set in the step 202, the station checks whether or not another AP exists and stores the result into the internal buffer (steps 203 and 204).

(3) The station updates the checking CH number n to n+1, in other words, the station updates the CH number by one for the next record of the selected group table, and resumes communication using the link CH that was being used by the station and was stored in the step 201 (steps 205 and 206).

(4) The station keeps performing its own communication at the step 206 and then determines whether or not the check for all CHs in the group table is completed. If it is not completed, the station returns to the step 203 and repeats the processing until the check for the all CHs in the group table is completed (step 207).

(5) From the determination of the step 207, when the check for all CHs in the group table is completed, the station updates the group table number m to m+1, and while reporting to the OS information of the checked result stored in the buffer, it keeps performs its own communication until the next background scan instruction is received from the OS (steps 208 and 209).

(6) When the next background scan instruction is received from the OS, the station determines whether or not the processing for all CHs in the group table is completed by the preceding background scan. If it is not completed, the station returns to STEP 203 and performs the processing for the CH in the next group table updated in the step 208. Further, when the processing for all group tables is completed, the station returns to the step 201 and repeats the processing again (step 210).

An approach to grouping the CHs which may be available to the AP into a plurality of groups will now be described.

For CHs that can be allocated to the 2.4 GHz range, there may exist 14 channels of CH1 to CH14. However, it may be difficult for the closely arranged APs to use the adjacent CHs because the spectrums may be overlapped. For this reason, typically, the adjacent CHs may not be allocated to the closely arranged APs. Therefore, groups of CHs in which CH1, CH6 or CH11 are combined, or other groups of CHs in which CH2, CH7 or CH12 are combined can be allocated, for example. That is, the number of APs having the overlapped service areas among the APs using the 2.4 GHz range may typically 3. This may be substantially true for the 5.0 GHz range.

Further, taking into account the method of allocating CHs into the APs as described above, the method groups CHs, and for each group, stores CHs belonging to the group in the group table, such that the background scan may be efficiently performed.

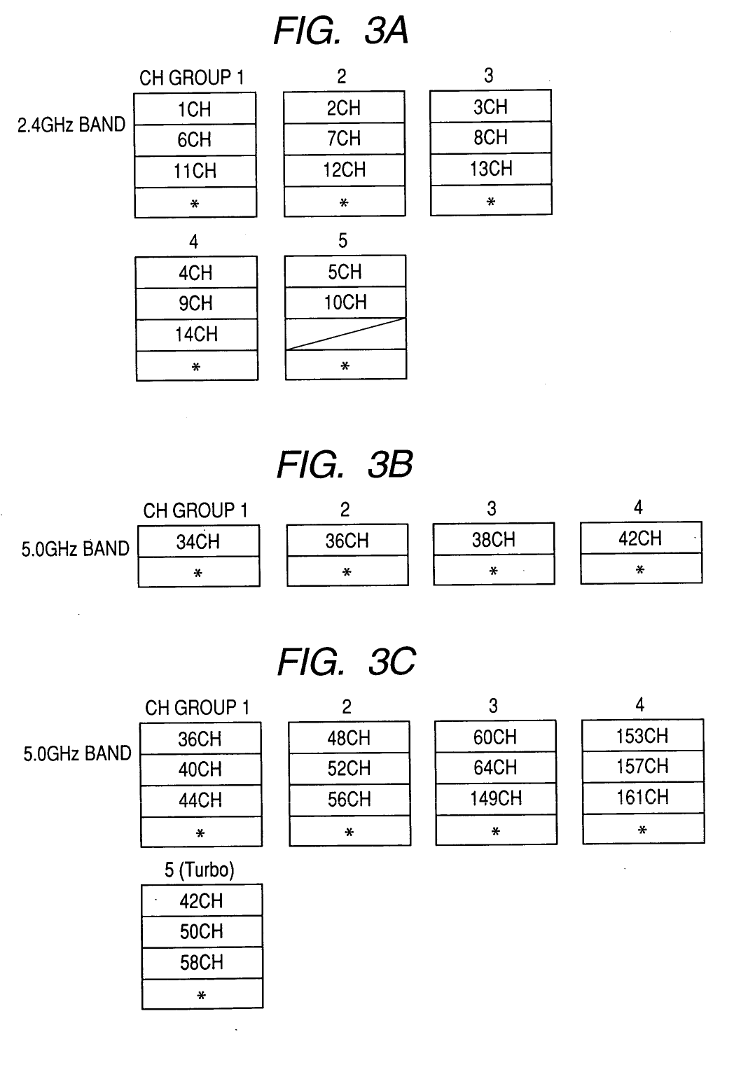

An example of a construction of group tables in which the CH numbers are stored in FIGS. 3A and 3B, conforming to Japanese domestic environment where the 2.4 GHz range and the 5.0 GHz range are effective.

As shown in FIG. 3A, for the 2.4 GHz range, the group table 1 registers CH1, CH6 and CH11, the group table 2 registers CH2, CH7 and CH12, the group table 3 registers CH3, CH8 and CH13, the group table 4 registers CH4, CH9 and CH14, and the group table 5 registers CH5 and CH10. Further, as shown in FIG. 3B, the group tables 1 to 4 of the 5.0 GHz range registers CH34, CH36, CH38 and CH42, respectively. (The table entries marked with an asterisk will be described later.)

In the above-mentioned processing of the flowchart shown in FIG. 2, the group table 1 of the 2.4 GHz range and the group table 1 of the 5.0 GHz range are taken as one group, and the group table 2 of the 2.4 GHz range and the group table 2 of the 5.0 GHz range are taken as one group. For this reason, in the processing of the flowchart shown in FIG. 2, after the processing for the group table 5 of the 2.4 GHz range is completed, the station returns to processing from the step 201.

Further, for the processing shown in FIG. 2, the group table selected in the beginning of the processing in the step 202 is a table that includes the CH that may be presently used for communications in the station itself and stored into the internal buffer through the processing of the step 201. For example, when the CH1 is used to perform current communication in the station itself, the group table 1 is selected. In contrast, when CH7 is presently used for communications, group table 2 is selected.

Since the group table is selected in such a manner, when there is another AP closely located to the AP that performs current communication, it is quite probable that another AP uses a CH which may be stored in the same group table, as described above. Therefore, an existence of another AP that can be communicated with may be promptly detectable. Thus, when it is difficult to communicate using the CH used in the current communication, a connection link may be rapidly established with a new AP.

While an embodiment of the method has been described in connection with Japanese domestic environment, the table allocations may correspond to WWR (world wide roaming). In this case, the group table shown in FIG. 3A may be used for the group table of the 2.4 GHz range and the group table shown in FIG. 3C may be used for the group table of the 5.0 GHz range.

Further, for the processing illustrated in FIG. 2, the embodiment of the present invention has been described that the group table of the 2.4 GHz range and the group table of the 5.0 GHz range having the same numbering may be regarded as one group. Alternatively, the method can be also configured that the group table of the 2.4 GHz range and the group table of the 5.0 GHz range may be separately processed. Further, the newest numbered one among the CHs possessing a specified SSID (Service Set IDentifier) or other identifying characteristic can be saved into locations designated by an asterisk ‘*’ in each table shown in FIG. 3, so that roaming may be reduced.

This reduces the time required for one background scan based on the instruction from the OS, so that the background scan can be performed with less impact on the communication function of the station.

It would be understood by persons skilled in the art that the frequency bands used to illustrate the method represent existing radio frequency allocations. The assignment of radio frequency bands may change due to administrative actions, and may vary from country-to-country or even within a country by geographical area, and the method may be adapted to encompass these changes.

Although more than one frequency band is used to illustrate the method, the method is equally applicable to CHs contained in a single frequency band.

Although the present invention has been explained by way of the embodiments described above, it should be understood to the ordinary skilled person in the art that the invention is not limited to the embodiments, but rather that various changes or modifications thereof are possible without departing from the spirit of the invention. Accordingly, the scope of the invention shall be determined only by the claims and their equivalents.

1. A method of determining the availability of a channel of a plurality of channels for communications by a station with access points in a wireless communication system, the method comprising:
allocating channels available for assignment to the access points to a plurality of groups;
selecting a group from the plurality of groups;
checking the channels assigned to the selected group to determine a channel status of each channel in the selected group;
reporting the channel status of each channel of the selected group;
selecting another group from the plurality of groups; and
repeating the checking the channels, the reporting the channel status and the selecting another group.

2. The method of claim 1, further comprising initiating the checking of the group selected first by an instruction from an operating system (OS).

3. The method of claim 1, further comprising initiating the determining the channel status by an instruction from an operating system (OS).

4. The method of claim 2, wherein the OS comprises instructions stored in one of volatile or non-volatile memory.

5. The method of claim 1, wherein the channel status is reported to an operating system (OS).

6. The method of claim 1, wherein channels having a high probability of assignment to the access points having overlapping communications coverage areas are allocated to one of the plurality of groups.

7. The method of claim 1, wherein the communications between the station and one of the access points occurs interleaved with the checking of the channel status of the channels of the selected group.

8. The method of claim 1, wherein the allocating the channels into each group of the plurality of groups includes the channels in a 2.4 GHz band and the channels in a 5.0 GHz band.

9. The method according to claim 1, wherein the group containing the channel over which the station itself is communicating with one of the access points is selected first.

10. The method of claim 1, wherein channels having adjacent center frequencies are allocated to different groups.

11. The method of claim 1, wherein each group has a record location for the channel which has most recently met a selection criteria.

12. The method of claim 11, wherein the selection criteria comprises reception of a desired Service Set Identifier (SSID).

13. The method of claim 1, wherein the allocation of channels to each group includes at least one channel in the 5.0 GHz band.

14. The method of claim 8, wherein each group is allocated channels from the channels in the 2.5 GHz band and the channels in the 5.0 GHz band.

15. The method of claim 14, wherein channels having adjacent center frequencies are allocated to different groups.

16. The method of claim 1, wherein the access points are a part of a wireless LAN.

17. The method of claim 8, wherein at least one of the groups includes at least one channel selected from the 2.5 GHz band and one channel selected from the 5.0 GHz band.

18. The method of claim 16, wherein each of the access points in the wireless LAN is assigned the same Service Set Identifier (SSID).

19. A method of determining the availability of a channel for communications between a station and access points in a wireless communication system, the method comprising:
(1) receiving an instruction to perform a background scan from an operating system (OS);
(2) determining if the background scan is in progress;
(3) completing the background scan in progress, and returning to step (1), else continuing to step (4);
(4) selecting a group of channels of m groups of channels, m being an intiger, the group of channels including the channel currently being used for communications by the station, each group of channels comprising n channels, n being an integer characteristic of each group of channels;
(5) storing channel information relating to a communications link which the station in the wireless communications system is currently using for communications;
(6) interrupting communications by the station;
(7) checking one of the n channels to determine if one of the access points is associated with the channel;
(8) storing a checking result for the checked channel;
(9) resuming communications by the station using the stored channel information;
(10) repeating the method starting at step(6), until the n channels in the group have been checked;
(11) selecting another one of the groups of channels and repeating the method, starting at step (6), until the m groups have been checked; and
(13) reporting the stored checking result for each checked channel to the OS.

20. The method of claim 19, wherein reporting the checking result is performed after the n channels of the selected group have been checked.

21. The method of claim 19, wherein reporting the checking result is performed after each of the n channels of the selected group has been checked.
